(19) United States
(12) Patent Application Publication
(10) Pub. No.: US 2014/0269791 A1
(43) Pub. Date: Sep. 18, 2014

(54) Generation Of Multioctave Coherent Light Harmonics

(71) Applicant: Oewaves, Inc., Pasadena, CA (US)

(72) Inventors: Wei Liang, Pasadena, CA (US); Andrey Matsko, Pasadena, CA (US); Lute A. Maleki, Pasadena, CA (US); Anatoily A. Savchenkov, Pasadena, CA (US); Vladimir S. Ilchenko, Pasadena, CA (US); David Seidel, Pasadena, CA (US)

(73) Assignee: Oewaves, Inc., Pasadena, CA (US)

(21) Appl. No.: 14/209,625

(22) Filed: Mar. 13, 2014

Related U.S. Application Data
(60) Provisional application No. 61/783,923, filed on Mar. 14, 2013.

(51) Int. Cl. G02F 1/35

(52) U.S. Cl. CPC G02F 1/353
USPC 372/22

(57) ABSTRACT

A light spectrum generator uses an input continuous light source well within the normal GVD of a resonator to produce a multi-wavelength spectrum having irregularly spaced harmonics that could span wavelengths of more than six octaves from one another. Combined with a tuner that adjusts the power and wavelength of the light source, a turner that adjusts a temperature or a pressure applied to the resonator, and a filter, the generator could be used to produce any wavelength of light between 0.1 and 10 μm.

This application claims priority to U.S. Provisional Application No. 61/783,923 filed Mar. 14, 2013, which is incorporated by reference in its entirety.

### FIELD OF THE INVENTION

The field of the invention is light spectrum harmonics.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Device that produce a large spectrum of light is useful to produce light at different frequencies. The Science AAAS paper Generation and Photonic Guidance of Multi-Octave Optical-Frequency Combs published 2007 by F. Couny et. al. (hereinafter “Couny”) shows that a spectral comb could be generated that covers more than three octaves of frequency using a single pump laser emitting light within the anomalous GVD region of a hollow-core photonic crystal fiber. Couny's crystal fiber, however, only produces regularly spaced frequency combs, and the frequency combs only span a few octaves. Regularly spaced frequency combs produce every sidebands, as the amplitude of a harmonic decreases the further the harmonic is from the “center” of the comb.

US20120294319 to Maleki teaches a system that generates a frequency comb using a continuous wave laser emitting light within the anomalous GVD region of a whispering gallery mode (WGM) resonator, where the frequency comb spans less than 200 nm. While Maleki's frequency comb has amplitudes that are asymmetric, the spacing between peaks of Maleki's comb were regularly spaced, which could still waste energy. In addition, Maleki's frequency comb spanned less than an octave.

Thus, there remains a need for a system and method that produces light at different frequencies that spans a plurality of octaves and has irregularly spaced peaks of differing amplitudes.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. A light source that is functionally coupled to a resonator is one that is configured to send a beam of light from the light source to the resonator through the coupling device, which is usually some sort of prism or lens.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The inventive subject matter provides apparatus, systems, and methods to generate a multi-octave spectrum of light using a nonlinear resonator that produces a multi-wavelength spectrum that spans a plurality of octaves, where the input light has a wavelength within a normal group velocity dispersion (GVD) wavelength region of the resonator. Such a configuration produces a spectrum having peaks that are irregularly spaced, and could be configured to have one or more “master peaks” that have an amplitude at least one, two, three, or four orders of magnitude greater than any of the other peaks. As used herein a “nonlinear resonator” is an optical resonator having nonlinear effects with respect to the produced output light. As used herein, a normal GVD wavelength region of a resonator is located at least 5%, if not 10% or 20% away from the wavelength of a zero GVD point of the resonator, where the resonator has a positive GVD. Preferably, the input wavelength is located at least 50, 100, or even 200 nm away from any zero GVD point of the resonator.

The resonator is generally configured to receive an input light to produce the coherent beam having a multi-wavelength spectrum, for example through a coupling prism or a collimating lens, as disclosed in co-owned applications US20120294319 and US20130003766. While the input light is preferably a laser that emits a continuous wave or pulsed transmission having a wavelength within the normal GVD wavelength region of the resonator, preferably at least 5%, 10%, or even 20% into the normal GVD wavelength region of the resonator, as measured from the closest zero GVD wavelength. For example, where the resonator comprises calcium fluoride, where the zero GVD wavelength point is at 1550 nm, the input light preferably has a wavelength of at most 1470 nm, 1395 nm, or 1240 nm. One embodiment of a calcium fluoride resonator uses an input wavelength of 780 nm. Other contemplated resonator materials include magnesium fluoride, silica, and silicon nitride.

The resonator is preferably configured to have an optimal morphology to facilitate phase matching of a nonlinear process. Contemplated resonators include mirrored lenses, total internal reflection resonators, and whispering gallery mode (WGM) resonators. The resonator's morphology could preselect a mode family of the resonator by being shaped to degrade a Q factor of a resonator, or to ensure that only selected mode families are accessible by the input light source. For example, a WGM resonator could be shaped so that only one mode family is accessible to an optical coupling apparatus (such as a prism, waveguide, or optical grating) via a corner of the resonator, and the input light source could then be functionally coupled to the corner of the resonator through the optical coupling apparatus that abuts that corner.

In some embodiments, a filter could be provided that receives the output beam emitted by the resonator, and splits the beam into a spectrum having distinct coherent harmonics of light. Such a filter could be, for example, a reflective grating that reflects a first order of the diffracted beam towards one location, and the zero order of the diffracted beam towards another location. The harmonics of light could be, but are not necessarily, irregularly spaced in frequency space, and have wavelengths that are generally separated by at least 0.1, 1, 5, or even 9 or 10 μm. In some embodiments, the first wavelength is at most 1 μm and the second wavelength is at least 9 μm. Exemplary generated harmonics have spanned from 0.1 to 10 μm—differing by at least two, three, four, five, and even size octaves. As a result of such a large range of harmonics, the harmonics could comprises both visible and non-visible light.

The spectrum could be directed towards other filters that are used to select a subset of the projected harmonics. A filter could be used to only select infrared light, while another filter could be used to select only visible light, while yet another filter could be used to select only wavelengths between 600 nm and 700 nm. A user could use such filters to create, for example, a white light generator.

A light source tuner could be coupled to the input light source to alter a power level and wavelength/frequency of the input light and/or a resonator tuner could be coupled to the resonator to alter a temperature or a pressure applied to the resonator. The light source tuner could alter a frequency of the input light to alter the phase-matching conditions of the resonator, which in turn alters the types of harmonics found in the spectrum. A device having such tuners and filters could conceivably be used to conceivably generate any output light between 0.1 to 10 μm, depending upon the transparency of the resonator host material.

Various objects, features, aspects and advantages of the inventive subject matter will become more apparent from the following detailed description of preferred embodiments, along with the accompanying drawing figures in which like numerals represent like components.

One should appreciate that the disclosed techniques provide many advantageous technical effects including the generation of a large variety of harmonics across a spectrum that spans many octaves, the generation of a few irregularly spaced harmonics across such a spectrum, and the ability to generate a large variety of light of different wavelengths with a single apparatus.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 is a schematic of an exemplary multi-wave spectrum generator of the present invention.

FIG. 2A, 2B, and 2C show exemplary spectrums generated by the exemplar multi-wave spectrum generator of FIG. 1.

FIG. 3 shows a spectrum of a generated signal taken using two different optical spectrum analyzers.

FIG. 4 shows an exemplary frequency spectrum generated by an exemplary resonator due to an avoided mode crossing that enables oscillation.

FIG. 5 shows an exemplary RF frequency spectrum generated by an exemplary resonator.

FIG. 6 shows exemplary optical harmonics from two independent optical parametric oscillator processes.

FIG. 7 shows a transparent box package.

### DETAILED DESCRIPTION

In FIG. 1, an exemplary multi-wave spectrum generator 100 generally has a light source 110, focus lens 120, prism 130, resonator 140, collimating lens 150, reflective grating 160, and screen 170.

Light source 110 is shown here as a laser, which is configured to emit a continuous wave transmission or a pulsed transmission, but could be any light source suitable to trigger nonzero cubic linearities in resonator 140. Preferably, light source 110 is an adjustable eagleyard DFB laser that is configured to provide a continuous wave transmission at a plurality of frequencies within the normal GVD region of resonator 140. Light source 110 preferably has a tuner that alters the frequency and/or power of the input light source to the properties of the output beam from resonator 140.

The laser light is focused by a focus lens 120 towards prism 130, which serves a dual purpose of directing laser light from focus lens 120 towards resonator 140, and directing an emitted beam from resonator 140 towards collimating lens 150. Prism 130 acts as an optical coupling apparatus that functionally couples focus lens 120 and collimating lens 150. While a prism is preferred, any suitable optical coupling apparatus could be used, for example a waveguide or an optical grating. A preferred prism material is BK7.

Resonator 140 is shown here as a whispering gallery mode resonator made from a material suitable to exhibit nonzero cubic nonlinearities at a plurality of mode families, although other resonators are contemplated, such as total internal reflection resonators and mirrored lenses. Preferred resonator materials include calcium fluoride (CaF₂) and magnesium fluoride (MgF₂), chosen for their high level of transparency (allowing them to generate a beam of light having a broad spectral width between 150 nm and 10 μm) and ability to generate beams of light with a high Q factor (F>10⁷) using an input light of a low power. Resonator 140 generally generates spectrums due to a hyper-parametric oscillation process, where at least two pump photons are absorbed and at least two emitted photons are emitted at different frequencies than the absorbed photons. The frequencies of the emitted photons are defined by the energy conservation law and phase matching conditions.

Resonator 140 is preferably selected from a material and is shaped to induce at least one nonlinear process: resonant opto-mechanical oscillation (OMO), resonant stimulated Brillouin scattering (SBS), optical parametric oscillation (OPO) and stimulated Raman scattering (SRS). While OMO and SBS resonators tend to have the lowest thresholds and could be suppressed efficiently by a selection of proper resonator geometry that does not support phase matching of the process, SRS has much weaker phase matching requirements and can involve high order WGMs having higher Q-factors. Preferably, resonator 140 is sized and disposed to induce OPO nonlinearities when a laser is aimed at the resonator.

A tuner (not shown) is preferably coupled to the resonator to alter the output beam by altering either a temperature of the resonator or altering a pressure imparted to the resonator. In one embodiment, the tuner comprises a heat source situated at most 10 mm, 5 mm, or 1 mm from a surface of the resonator, which applies heat to the resonator depending upon a setting of the tuner. In another embodiment, the tuner comprises a plate coupled to a major surface of the resonator (where the major surface is a flat surface with the largest surface area) which applies pressure to the resonator in response to an electric stimulus.

Resonator 140 is sized and disposed to have at least 2 mode families, and preferably has at least 4 mode families, where the GVD within each mode family is normal, so that hyper-parametric oscillation is suppressed within each mode family. The shape of the resonator is preferably engineered so that the overlap integral F between at least three of the optical modes, belonging to at least two mode families, is nonzero.

$$F = {\int }_{V} {E}_{1}^{2} {E}_{2}^{*} {E}_{3}^{*} d {r}^{3}$$

Here, E₁ is the E-field amplitude of the mode pumped with cw light from light source 110, while E₂ and E₃ are the E-field amplitudes of the modes, where either E₂ or E₃ belong to a mode family different from the mode family that E₁ belongs to. While E₂ and E₃ preferably belong to different mode families, E₂ and E₃ could belong to the same mode family without departing from the scope of the current invention. V is the volume of the resonator, and * stands for complex conjugated value. Where E₁, E₂ and E₃ each belong to different mode families, the three modes should be equidistant, or nearly equidistant, from one another. (i.e. the frequencies of the modes are related as |2w₁-w₂-w₃|<<|w₁-w₃|. Preferably, 2w₁-w₂-w₃<0.

In one embodiment, the resonator is non-ideal such that at least one of the three mode families (corresponding to E₁, E₂ and E₃, respectively), experiences an avoided mode crossing with a mode family different from the three mode families. The avoided mode crossing operates to shift the mode frequency as needed. As used herein, an “ideal” resonator is one that is substantially spherical, toroidal, or cylindrical (the cross section is substantially circular, where any point along the perimeter of the “circle” is equidistant from the center by at most a 5% deviation). In another embodiment, the resonator is ideal, and the mode interaction is enabled by placing an artificial distorter (for example a piece of glue or glass) within the evanescent field of the open dielectric resonator. In yet another embodiment, E₁, E₂ and E₃ all belong to the same mode family, but at least one of E₁ is shifted due to an interaction with a mode of a different family, resulting in an avoided mode crossing.

In another embodiment, the resonator and input light are configured to phase match the frequency tripling oscillation where three pump photons are absorbed and a single photon resulting from the nonlinear process is emitted. In order to accomplish this, the resonator should be configured such that the following integral F₁ is nonzero.

$${F}_{1} = {\int }_{V} {E}_{1}^{3} {E}_{2}^{*} d {r}^{3}$$

Where E₁ is the E-field amplitude of the mode pumped with cw light, and E₂ is the E-field amplitude of the mode where triple frequency light is generated. Similar to the configuration above, E₂ could either belong to a different mode family than E₁, or E₂ could belong to the same mode family as E₁, but be shifted in frequency by interaction with a third mode belonging to a different mode family.

The input light directed to resonator 140 is preferably pumped with light nearly resonant with mode E₁.The light could be locked using any suitable locking mechanism, for example thermal, self injection, or Pound-Drever-Hall locking. The emitted light beam from the resonator is then directed towards collimating lens 150 by prism 130, which directs the light beam towards reflective grating 160, which acts as an optical filter to direct the first order harmonics towards screen 170. Both prism 130 (or a comparable optical coupling apparatus) and collimating lens 150 are preferably made from a material that is transparent in the frequency regions the modes E₁, E₂ and E₃ belong to in order to facilitate transmission of the entire spectrum.

In some embodiments, the harmonics have wavelengths which are at least 50 nm different from one another, and are separated by at least 100 or 200 THz from the optical pump wavelength frequency. Because of the significant wavelength difference between the OPO harmonics, it is possible to efficiently separate the wavelengths from one another using a diffraction grating. This wouldn't be possible with prior art comb spectrums, as many of the tines of a comb are only separated by a few nm, and can't be separated well using a grating. The resonator is also preferably sized and dimensioned to reduce the number of sidebands of the resulting spectrum to only a pair in order to generate high power harmonics. Altering the detuning of the laser could alter the generated harmonics of the spectrum.

In an alternative embodiment, the beam from collimating lens 150 is split using a fiber coupler (not shown), where part of the light is sent to an optical spectrum analyzer for recording the spectra, and part of the light is sent to a fast photodetector to observe the beat signal of the generated frequency spectrum. This allows fine tuning of the spectrum while the resonator or input light is tuned. The resulting output beam could also be used to seed even higher power lasers.

### EXAMPLE

In one experiment, a MgF₂ resonator having a 7 mm diameter with a thickness of 100 μm (having a free spectral range of 9.9 GHz), was functionally coupled to a Bk7 prism that directed light from an eagleyard DFB and a reflective holographic grating 1800/mm. The resonator has a zero GVD point at 1550 nm, where any input wavelength less than 1500 nm is within the GVD normal region. A GRIN focus lens was used to focus the laser to match the numerical aperture (N.A.) of the mode of the resonator, and the threshold of the laser 33 mA. Since the free running linewidth of the laser exceeds 1 MHz, the self-injection locking technique was used to pump the laser. The laser was locked to a mode of the resonator through injection locking, and the resonator achieved a loaded Q factor of at least 5×10⁹ at 780 nm, and 10¹⁰ at 689 nm. Oscillation was observed with less than 1 mW of optical power coupled into the mode of the resonator, and at a lser current as low as 43 mA. Both being well within the normal GVD range for the resonator. By manipulating the power of the input light, the spectrum could generate harmonics from UV (360 nm) to near IR (1500 nm). By sweeping the current of the laser, the laser could also interrogate different modes of the resonator. Manipulating the temperature of the resonator also provides a greater ability to manipulate the spectrum.

In FIGS. 2A, 2B, and 2C, different visual spectrums are observed that are generated by sweeping the frequency of light from the laser from 600 nm to 800 nm. In FIG. 2a, light harmonics 201, 202, and 203 are generated, producing two high harmonics of a high power (harmonics 202 and 203) and one harmonic of a low power (harmonic 201). In FIG. 2b, light harmonics 221, 222, 223, 224, 225, 226, 227, 228, 229, and 230 are generated, producing many harmonics of relatively low power. In FIG. 2c, light harmonics 241, 242, 243, and 244 are generated, producing two high harmonics of a high power (harmonics 242 and 243) and two harmonics of a lower power (241 and 244). In each of the FIGS. 2a-2c, the far left spot, 201, 221, and 241 respectively, corresponds to the wavelength of the input light source. Thus, by tuning the laser or the resonator, the disclosed multi-wavelength spectrum generator can generate wavelengths of very high power that are not regularly spaced combs. As used herein, a generated light of a high power has an amplitude at least 2 times as large as a generated light of a low power, and preferably has an amplitude at least 3 or 4 times as large as the generated light of the low power.

FIG. 3 shows a spectrum of a signal generated by the experimental multi-wavelength spectrum generator using two different optical spectrum analyzers, where the closest to the carrier on the red side is the first order SRS Stokes line. The frequency spectrum of the oscillation signal for the optical pumping exceeded the threshold by about two orders of magnitude (50 mW of pumping). As shown, the spectrum covers more than four frequency octaves, which has never been achieved before using an input light within the normal GVD range of the resonator. The spectrum is aperiodic, and the density of the spectrum increases in the region of the normal GVD. The loading of the resonator also decreases with wavelength decrease, which increases the probability of optical conditions for the four wave mixing processes.

FIG. 4 shows an example of the fundamental frequency spectrum generated in the resonator due to avoided mode crossing that enables the oscillation, and FIG. 5 shows the RF frequency signal generated at the photodiode by the generated frequency spectrum. FIG. 6 shows optical harmonics generated from the experimental resonator from two different OPO processes. In FIG. 6a, the resonator is pumped with 20 mW of 780 nm light, where in FIG. 6b, the resonator is pumped with 25 mW of optical power at the same frequency. A greater number of harmonics are generated with the slightly higher power laser (shown in FIG. 6b) at irregular intervals, originating from two OPO processes as well as SRS. Line 1 is located 52.4 THz, line 2 is located 74.5 THz from the carrier, and line 3 is located 12.3 THz from the carrier.

FIG. 7 shows a transparent box package 700 having a resonator 710, coupling prism 720, and a package 730. Transparent box package 700 ensures that the resonator works well within a clean room environment. Package 730 is preferably made of glass, and is capable of sustaining at least a 100 nm air gap between the surface of resonator 710 and coupling prism 720. A conductive plate (not shown) could be coupled to any surface of package 730 to allow a tuner to manipulate the temperature of the resonator by increasing or decreasing power sent to such a conductive plate.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An apparatus for generating a multi-octave spectrum of light, comprising:
a light source that provides an input light; and
a nonlinear resonator configured to receive the input light and produce a coherent output beam having a multi-wavelength spectrum that spans at least two octaves, wherein the input light has a wavelength within a normal GVD wavelength region of the resonator.

2. The apparatus of claim 1, wherein the input light comprises at least one of a continuous wave transmission and a pulsed transmission.

3. The apparatus of claim 1, wherein the nonlinear resonator comprises calcium fluoride.

4. The apparatus of claim 3, wherein the input light has a wavelength of at most 1000 nm.

5. The apparatus of claim 1, wherein the nonlinear resonator comprises magnesium fluoride.

6. The apparatus of claim 1, wherein the nonlinear resonator exhibits nonzero cubic nonlinearities.

7. The apparatus of claim 1, wherein the light source comprises a laser that produces a wavelength of light at least 5% of a zero GVD wavelength into the normal GVD wavelength region of the resonator.

8. The apparatus of claim 1, further comprising a filter that produces a spectrum having distinct coherent harmonics of light.

9. The apparatus of claim 8, wherein the harmonics of light are irregularly spaced in frequency space.

10. The apparatus of claim 8, wherein a first wavelength of a first harmonic of light and a second wavelength of a second harmonic of light span at least 5 μm.

11. The apparatus of claim 10, wherein the first wavelength is at most 1 μm and the second wavelength is at least 9 μm.

12. The apparatus of claim 8, wherein the harmonics of light comprise visible and non-visible light.

13. The apparatus of claim 8, further comprising a second filter that directs only one of the harmonics of light towards an output light path.

14. The apparatus of claim 8, wherein a wavelength of a first coherent harmonic of the distinct coherent harmonics differs from a second coherent harmonic of the distinct coherent harmonics by at least two octaves.

15. The apparatus of claim 8, further comprising a tuner that alters a frequency of the input light, wherein a change in frequency of the input light results in altering the phase-matching conditions of the resonator.

16. The apparatus of claim 15, wherein the tuner alters the frequency of the input light by altering a power input to the light source.

17. The apparatus of claim 15, wherein a first tuner setting selects a first wavelength of light to output through an output beam path and a second tuner setting selects a second wavelength of light to output through the output beam path.

18. The apparatus of claim 15, wherein the tuner alters the output beam by altering a temperature of the resonator.

19. The apparatus of claim 15, wherein the tuner alters the output beam by altering a pressure imparted to the resonator.

20. The apparatus of claim 1, further comprising a filter that selects a single coherent harmonic having a wavelength different from the input light wavelength.
